(19) United States
(12) Patent Application Publication
(10) Pub. No.: US 2006/0006230 A1
(43) Pub. Date: Jan. 12, 2006

(54) Smart card network interface device

(76) Inventors: Alon Bear, Haifa (IL); Dror Zernik, Haifa (IL)

Correspondence Address: DANIEL J SWIRSKY, 55 REUVEN ST., BEIT SHEMESH, 99544, IL

(21) Appl. No.: 10/531,285

(22) PCT Filed: Oct. 16, 2003
(86) PCT No.: PCT/IL03/00843

§ 371 Date: Apr. 14, 2005

Related U.S. Application Data
(60) Provisional application No. 60/418,338, filed on Oct. 16, 2002.

(51) Int. Cl. G06K 7/00; G06K 7/06

(52) U.S. Cl. 235/435; 235/441

(57) ABSTRACT

A securely identifiable network device is provided. The device may be directly hooked to a network or Internet via a phone or other communication interfaces. The device includes a smart card reader and a communications interface, such as a MODEM, RS-232, infra-red interface, RF, tone, or an Ethernet interface, and a minimal device controller. The combination of these components allows for generating a fully authenticated access to a networked data server (e.g. mail, SMS, phone switch), for personalizing the access point behavior, and for notifying the data provider about the current location of the cardholder. This allows for re-routing the required data messages to the current location. The service data messages are typically SMS, MMS, e-mail and phone calls.

### FIELD OF THE INVENTION

The present invention relates to the field of smart cards and network services in general and in particular to a stand-alone device for reading smart cards and to a system and method for transmitting and receiving information through a network from a remote server to and from the smart card. The invention also refers to using the smart card for recording, editing and storing a user's personal preferences for use with the network access.

### BACKGROUND OF THE INVENTION

Network access devices today are either dumb (plain telephone, for example) and thus non-secure and non-personal, or extremely complex, (e g. a personal computer and cellular telephone). In the latter complex case, the identity and personality of the user are stored in the device. A standard telephone today may be “personalized” by associating functions with pre-defined keys. This is generally implemented by augmenting the telephones with memories that can be programmed. Typically, a “programmable telephone” has 10-20 quick-dial numbers. These numbers are typically programmed once, and therefore, the telephone cannot accurately be described as “personalize-able”—a personalize-able telephone may be defined as a telephone having adaptive characteristics depending on the user. Most telephones have a “redial” button, which is based on storing the last dialed number in local memory. Typically, there is no option to dial previous numbers except for the last number, as this requires both more memory, more control capabilities and a display screen. Furthermore, a standard telephone generally does not contain a controller and thus is incapable of performing control functions such as scrolling through a list of telephone numbers in order to select and dial a number.

Transferring an SMS (Short Messaging System) or an MMS (Multi-Media Message) requires a short data transmission and is typically carried out by either WAP, Data mode, or specialized control protocols over the cellular network. There are also services that allow a standard telephone user to listen to the text messages by converting the messages from text to speech in a specialized remote server. The sending of a text message from a standard landline phone is enabled if a specialized terminal is provided. However even with such a terminal the user's identity is not stored anywhere, and therefore it is not possible to automatically deliver messages to the user or to securely identify the sender.

Similarly, in order to receive common network services, such as e-mail, a complex computing device is provided, such as a cellular phone or a PC.

It would thus be advantageous to be able to personalize and be able to send and receive SMS, MMS and e-mail transmissions using a standard telephone, or wherever the network is accessible.

### SUMMARY OF THE INVENTION

The present invention is directed to a stand-alone device for reading and writing smart cards, which incorporate sufficient network access capabilities. The device may be integrated into a telephone or other network-accessing device, which can capture the network end-point. Furthermore, the general-purpose version of the device allows for access for any card application for any smart card Even when integrated into telephones (cellular or landline), for example, the device does not have to rely on specific telephone properties nor on the service provider, but rather it provides a general-purpose network access over telephone, or any other network media.

In a typical implementation of the invention, the smart card is used for storing the required application data, which contains at least the communication preferences (e.g. e-mail provider, IP address, or phone book), and the computing on the device is used at least for network interfacing. The device provides communication interfaces allowing the smart card to be exploited in its full potential utilizing the security capabilities of the smart card, and supporting authentication using the (optional) PIN (Personal Identification Number). If required, input and output for the user may be provided either through the telephone, or optionally, an on-device display and keyboard. Particularly, the card may be used for setting, saving, and recording the user's “personality” (that is, personal preferences) and identification (ID). The device may be used for initiating communication (for example, generating a call to an SMS server), or requesting the establishment of a network protocol, such as through a LAN to the user's mail server, for example.

The current invention describes a device that can configure a standard landline telephone with the personalization and authentication levels, and also a device which nay be configured to become a standalone network device, allowing for data services (SMS, MMS and e-mail) to be directed to the smart card.

There is thus provided, in accordance with an embodiment of the invention, a device that includes at least one smart card reader configured to communicate with a smart card and at least one network interface.

In addition, there is also provided, in accordance with an embodiment of the invention, a device that includes a Secure Information Module (SIM) configured to communicate with at least one network interface.

In addition, there is also provided, in accordance with an embodiment of the invention, a smart card that includes a network interface.

In addition, there is also provided, in accordance with an embodiment of the invention, a telephone that includes at least one smart card reader configured to communicate with SMS, MMS and e-mail servers.

The network interface may include one of a group including LAN (e.g. Ethernet), Wireless LAN (e.g. Bluetooth), landline phone (PSTN) (e.g MODEM), cellular phone (e.g. MODEM), peripheral-wire communication (e.g. RS-232), wireless communication (RF) infra-red (IR), and audio tones.

Furthermore, in accordance with an embodiment of the invention, the device may include a smart card reader configured to communicate with the SIM and the at least one network interface.

Furthermore, m accordance with an embodiment of the invention, the smart card may be configured to store identification (ID) data associated with the smart card and to store messages sent and received from SMS or MMS or e-nail servers.

Furthermore, in accordance with an embodiment of the invention, the device may be configured to support editing of SMS, MMS or e-mail messages.

Furthermore, in accordance with an embodiment of the invention, the device may further include an intern SIM and be configured to communicate with at least one network interface.

In a fixer embodiment of the invention, useful for some personalization functions, there is provided a system for remotely verifying the identification (authentication) of a smart card. The system includes the smart card device of the invention, interfacing with a remotely located server using communication over the preferred communication interface the server having means for verifying the validity of the smart card being read by the smart card device, and other data keyed into the device.

Furthermore, in accordance with an embodiment of the invention, the device may be configured to be connectable between a telephone and the wall socket of a telephone line or alternatively between a phone handset and the telephone base. Furthermore, in accordance with an embodiment of the invention, the smart card device may be configured to be connectable directly on a LAN, or any similar network.

Additionally, in accordance with an embodiment of the invention, the device may be provided with the required functionality of a standard phone. Scrolling keys and “execute” may be provided on the device or on the smart card, and the remaining keys either may be the standard telephone keys or provided w the device. The display may be either on the phone, the device or on the card itself The memory (data) may be mostly on the card and the control information, such as menus and default settings, for example, may be stored on the device or on the card.

Furthermore, in accordance with embodiment of the invention, smart card device further includes a display screen and keypad. The device may also include encryption means and a connector for external devices. The external devices may include a printer, a keypad, a display and a biometric data reader.

Furthermore, in accordance with embodiment of the invention, the power source includes at least one energy source from a group including an internal battery (rechargeable or non rechargeable), an external power outlet, and the communication media to which the device is coupled.

The smart card device may further include at least one of a group of processing components including additional computation capabilities, additional communication interfaces and additional encryption capabilities.

Furthermore, in accordance with embodiment of the invention, the smart card device may further include at least one memory component including Read Only Memory (ROM), Non-Volatile Memory AM) and Random Access Memory (RAM).

Furthermore in accordance with embodiment of the invention, the smart card may be configured to store identification (ID) data associated with the smart card, and to store messages sent and received from and to SMS or MM or e-mail servers.

Additionally, in a further embodiment of the invention, the device may be configured for sending and receiving messages from a standard phone and for identification of the user, using the capabilities of the smart card.

A possible application of the invention allows for establishing a “portable personality” where the SIM (Secure Information Module) (either the Smart Card itself or integrated into the device) stores all the user's personality parameters, for example the user's phone book, call lists, and user's identity for SMS, or e-mail.

Additionally, there is provided, in accordance with an embodiment of the invention, a method for personalizing a telephone connectable to a PSTN. The method includes the steps of connecting a device to the PSTN telephone line, the device includes a SIM (Secure Information Module) configured to communicate with the PSTN, and reading data stored on the SIM.

Furthermore, the method may further include the steps of selecting an action from a list of actions stored on either the SIM and activating the telephone to perform the selected action The step of activating may include at least one of a fist of actions including dialing a telephone number, sending an SMS or MMS or e-mail via a service provider or dedicated server, changing to a new list, adding and editing telephone numbers, allocating “quick dial” numbers and accessing a call register of received, dialed and missed calls; and storing the result of the steps on the SIM.

Furthermore, the method may further include the step of identifying the SIM owner. The SIM may be a smart card accessible through a smart card reader.

Additionally, there is provided, in accordance with an embodiment of the invention, a method for personalizing a telephone connectable to a PSTN. The method includes the steps of connecting a device to the telephone; the device includes at least one smart card reader configured to communicate with a smart card and the PSTN; and reading data stored on the smart card.

Furthermore, the method may further include the step of storing data on the smart card. The method may further include the steps of selecting an action from a fist of actions stored either on the smart card or on the device; and activating the telephone to perform the selected action. In addition, the method may further include the step of identifying the device.

Additionally, there is provided, in accordance with an embodiment of the invention, a method for receiving SMS and MMS and e-mail messages via a network interface. The network interface includes at least one of a group including a PSTN and LAN. The method includes the steps of connecting a device to the network interface; reading identification data (ID) from a SIM within the device or from a smart card; and performing a handshake with the SMS or MMS or e-mail server via the network interface.

Furthermore, the step of performing a handshake may include the step of transmitting the ID to the SMS or MMS or e-mail server, and the SMS or NM or e-mail server downloading SMS or MMS or e-mail messages, respectively associated with the ID of the SIM The SIM maybe an integral component of a smart card, or an integral component of the device.

Additionally, there is provided, in accordance with an embodiment of the invention, a method for automatically rerouting data services to current location. The method includes the steps of sending identification information stored on a SIM or a smart card to a service provider, and accepting the data messages and phone calls associated with the identification information at the current location. The data services may include at least one of a group including telephone calls, SMS, MMS and e-mail; and the current location may include one of a group including a landline phone connectable to a PSTN, a cellular phone, and a LAN access point.

Finally, there is provided, in accordance with an embodiment of the invention, a method for personalizing a telephone that includes a smart card reader and is connectable to a PSTN. The method includes the steps of re g telephone personalization data stored on smart card The method may further include the step of storing telephone personalization data on the smart card.

### BRIEF DESCRIPTION OF THE DRAWINGS

The above and other characteristics and advantages of the invention will be better understood through the following illustrative and non-limitative detailed description of preferred embodiments thereof with reference to the appended drawings, wherein

FIG. 1 is a schematic illustration of a prior art example of an operational environment for use with smart cards;

FIG. 2 is a schematic illustration of a smart card device constructed and operative according to an embodiment of the invention;

FIG. 2a is a schematic illustration of the smart card device of FIG. 2 hooked on to a standard telephone;

FIG. 2b is a schematic illustration of the smart card device of FIG. 2 hooked on to a standard telephone, between the handset and the base;

FIG. 3 is a schematic illustration of a smart card device, of FIG. 2 hooked on to a cellular telephone;

FIG. 4 is a schematic illustration of a smart card device, according to another embodiment of the invention;

FIG. 5 is a schematic illustration of a smart card device, according to another embodiment of the invention;

FIG. 6 is a flow chart illustration of an exemplary application utilizing the smart card device of FIG. 5; and

FIGS. 7 and 8 show additional flow chart illustrations of exemplary applications utilizing the smart card device of FIG. 5.

### DETAILED DESCRIPTION OF PREFERRED EMBODIMENTS

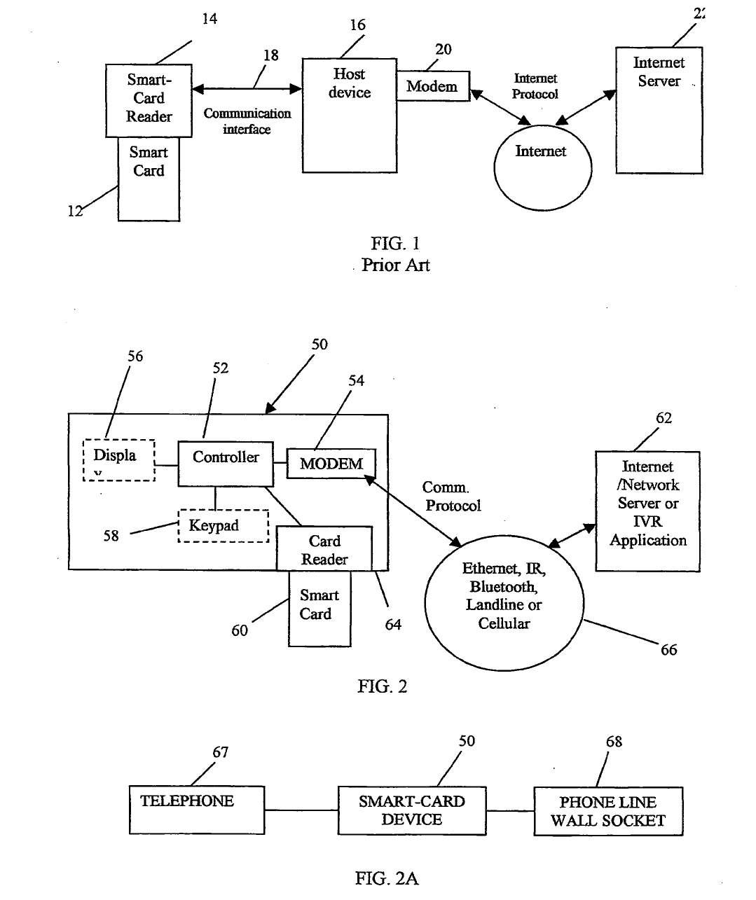

Reference is now made to FIG. 1, which is a schematic illustration of a prior art example of an operational environment for use with smart cards.

In the configuration of FIG. 1, which describes the prior art, a smart card 12, which may be inserted in a smart card reader 14 is in communication with a host device, such as personal computer (PC) 16. Communication between the card reader 14 and the host device 16 may be via any peripheral-device to PC communication interface, for example an RS-232 communication interface 18. A MODEM 20 is connected to host device 16.

Data is read from the smart card 12 by smart card reader 14 and transferred via the peripheral-device to communication interface 18. The Host device 16 manages the interactions with the card, and when desired it transfers information from and to host device 16 to and from the card 12. To transfer data onwards, the modem 20 may communicate with a remote server 22 via the Internet 24, using any Internet protocol, such as HTTP, or mail, for example, or secured protocols if desired. In a similar prior-art configuration, the reader may be embedded into the cellular phone, which serves as a host and carries much of the application's logic.

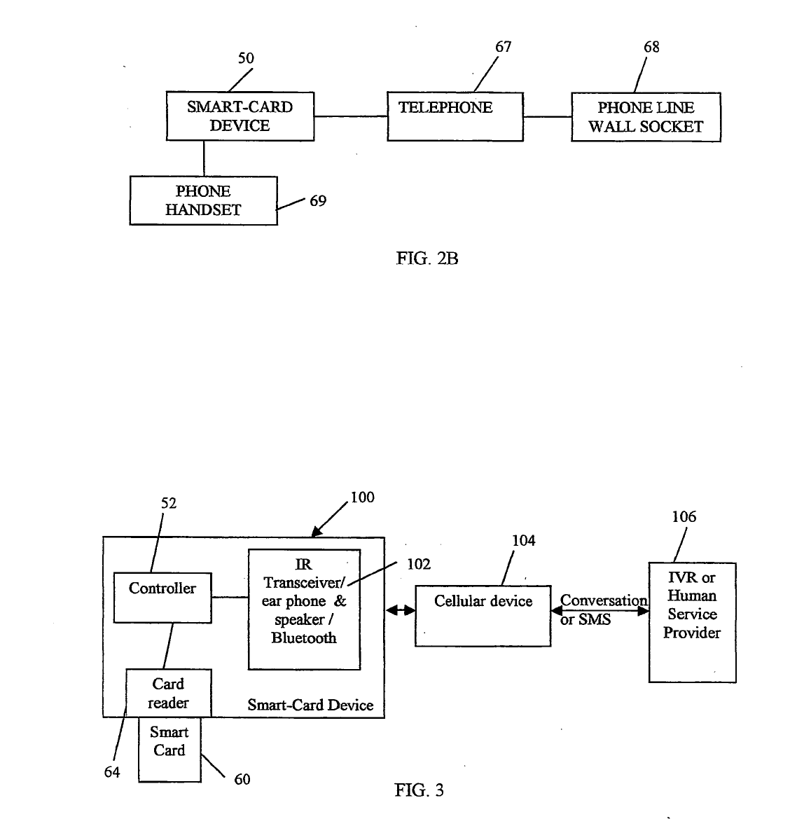

Reference is now made to FIG. 2, which is a schematic illusion of a smart card device, generally designated 50, according to an embodiment of the invention.

Smart card device 50 comprises a device controller 52 connected to a smart card reader 64 and a MODEM 54. It will be appreciated by persons knowledgeable in the art that the MODEM may be replaced by any other network interface component, such as Bluetooth, I-R, or Ethernet as examples. The controller 52 may comprise at least sufficient processing power for communication processing and optionally also for encryption and display capabilities. The processing may typically involve transferring and correctly packaging the card interface protocol to the desired communications protocol in order to control any of the embodied devices. The memory may include Read Only Memory (OM), Non-Volatile Memory (NVM) and Random Access Memory (RAM), for sample. A smart card reader 64 is connected to controller 52.

In a further embodiment of the invention, smart card device 50 may further comprise a display 56 and minima keypad 58 having at least one key, or ports for attaching external equipment, such as an external keypad (not shown), or a printer.

In yet additional embodiments of the invention, the device may contain an encryption device such as a SIM.

In yet additional embodiments of the invention, the device may contain a SIM for personalization. In this case, the smart card reader may be an internal reader, or alternatively both an internal and an external reader may be provided.

In yet additional embodiments of the invention, the device may contain a battery or an external power source. Alternatively, the specific communication media, to which the device is attached, may provide the power supply for the device and for the recharging of the battery, or power may be supplied from a combination of the above sources.

The smart card device 50 is configured to dial or hook into any network 66, such as a telephone network, for example, and complete a two-way protocol, with the server 62. The server 62 may be any suitable network server, such as an Internet server, mail, or an Interactive Voice Response server (IVR), depending on the desired network in use. In this embodiment, data is read from the smart card 60 by smart card reader 64 and transferred via MODEM 54 using voice-MODEM protocol, for example, to IVR Server 62. Personalization information may also be stored on the card, thus defining the desired communication target and communication preferences. In addition, since identification (ID) information is naturally stored on the card, the card may be used for authentication when desired.

In an exemplary embodiment, illustrated in FIG. 2a, the smart card device 50 may be coupled between a telephone instrument 67 and the wall-socket of the telephone line 68. Alternatively, as illustrated in FIG. 2b, the smart card device 50 may be coupled between a telephone handset 69 and the telephone base 67.

Similarly, in an exemplary embodiment illustrated in FIG. 3, a smart card device, generally designated 100 may be connected to a transceiver, such as a cellular telephone 104, via any of the cellular telephone interfaces (such as, IR, ear-phone-speaker, or Bluetooth), and provide all the required access functions to a remote server 106. The remote server 106 may be an IVR, mail, or human service provider, or an SMS server, for example.

In this figure (FIG. 3), smart card device 100 comprises a controller 52 connected to a smart card reader 64 (similar to the reader of FIG. 2) and coupled to an infra-red (IR) transceiver 102, or any other interface capable of being supported by cellular phones.

In the embodiment of FIG. 3, the device 100 transmits and receives the data read by smart card reader 64 via the IR transceiver 102 to an IR transceiver located within the cellular device 104, which may then act as a device controller for a specific application. For example, IR receiver 104 may cause the cellular phone to transmit authentication data read from the smart card 60 to remote server 106, using any of the cellular phone channels. After secure identification of the user and verification that ID matches the data from the smart card, the server 106 may yield data, which is then displayed on the device, stored on the card, stored on either the device or any combination thereof The data may be data from any remote data service such as SMS, MMS, and e-mail, for example.

In an alternative embodiment, the IR transceiver within the cellular phone 104 may allow the telephone's display and keyboard to be used The cellular phone may be used for fill human dialogue with the server 106.

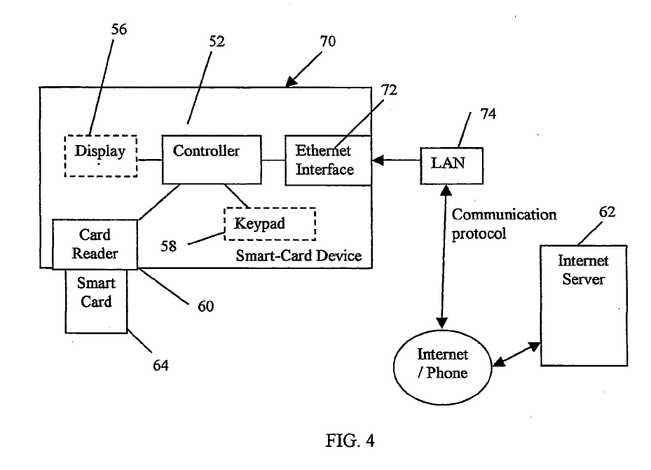

Reference is now made to FIG. 4, which is a schematic illustration of smart card device, according to another embodiment of the invention. Elements having similar functions have been designated with similar numerals and will not be described further.

FIG. 4 is a schematic illustration of a smart card device, generally designated 70, according to an embodiment of the invention. Smart card device 70 comprises a controller 52, which manages a smart card reader 60 (similar to the reader of FIG. 2), and an Ethernet interface 72 for a LAN (Local Area Network) 74. In this embodiment, the mart card device 70 is configured to utilize the Ethernet interface 72 and hook into a LAN 74, to access the Internet Server 62 directly from the device 70. The smart card 64 and the Internet server 62 can complete a client-server application over the Internet and LAN without any additional computer for mediation. The controller of the smart card device 70 simply acts as a communication enabler, establishing the link for a complete client-server configuration. In this embodiment, the data (such as e-mail or messages) may be downloaded directly to the card or the device where it may be stored and/or displayed.

The smart card device illustrated in the aforementioned embodiments may be used in many different applications, as will be described by reference to the non-limiting exemplary applications hereinbelow.

In an alternative embodiment of the invention the entire communication layer and support is implemented on the smart card. Such a smart card may contain, in addition to standard memory and computing capabilities, support of standard network access layers, such as software MODEM TCP-IP, for example.

In a further application of the present invention, the smart card device of the present invention may be used as a telephone personalization controller, where a user's personal data may be stored on the smart card.

When the personalized smart card is inserted into the device 50, which is hooked on a phone-cord between the telephone and the wall-socket (see FIG. 2A), or on the cord between the handset and the base (see FIG. 2B), it loads the personalized data into the controller and effectively converts the telephone into a personal instrument containing the user's selected profiles and identity. A user may have multiple profiles, such as a different profile for the office, home and for use when away from his base phone (in his car or ‘on the road’, for example). For example, quick dial 2 on the office profile may be used to dial his home when away from his base phone, but when used with the device at home maybe used for something else (say, the office). Alternatively, the device may dynamically acquire its own location information such as the network segment or area code, for example, directly from the network or by programming the device to establish the communication accordingly.

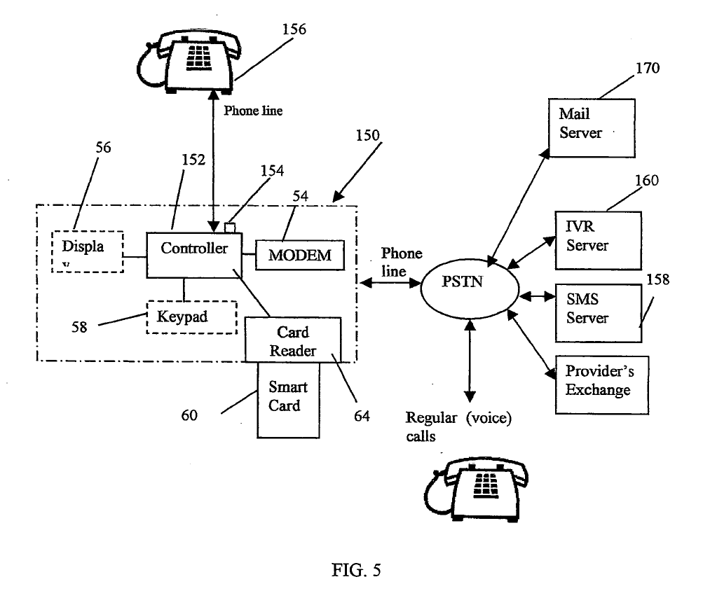

Reference is now made to FIG. 5, which is a schematic illustration of a smart card device 150, according to another embodiment of the invention Smart card device 150 is similar to smart card device 50 described hereinabove with respect to FIG. 2a. Components having similar functions have been similarly numbered and will not be described further.

Smart card device 150 compromises a controller 152 and at least one phone socket 154 for connecting the device to a standard telephone socket 156. The controller 152 is connected to a smart card reader 64 and a MODEM 54. It will be appreciated by persons knowledgeable in the art that the functions of the MODEM may alternatively be incorporated within the controller 152. Furthermore, the MODEM may be replaced by any other network interface component, such as Bluetooth, I-R, or Ethernet as examples.

Typically, the device 150 is located on the cable connecting the telephone 156 to the wall socket 154. Alternatively, the device 150 may be integrated either with the telephone or with the wall socket. In a typical configuration, the device may be permanently hooked on the phone-cord. In an alternative embodiment, it may be hooked between the phone and the handset (see FIG. 2B).

An alternative implementation and usage of the device does not require a telephone, but serves as a telephone message terminal, in which case the device is only connected to a phone socket.

In a further embodiment of the invention, the smart card device 150 may further comprise a display 56 and a keypad 58, and/or visual indicators such as LEDs (Light Emitting Devices)—not shown. Since a display enhances the capabilities of the device, it is preferable for the device to have its own display and not have to rely on a telephone having a display screen.

Using the device 150, the user can place regular voice calls (path-through via the PSTN), can interact with the device, place a call from lists stored on the smart card 60, or interact with specialized servers, such as SMS server 158, or application servers 160 that perform various dialogues with the card, such as identification, for example. The card and the server form a pair, consenting on the media type, protocol type, data types, and authentication level.

The smart card device 150 will now be described by reference to the non-limiting exemplary applications.

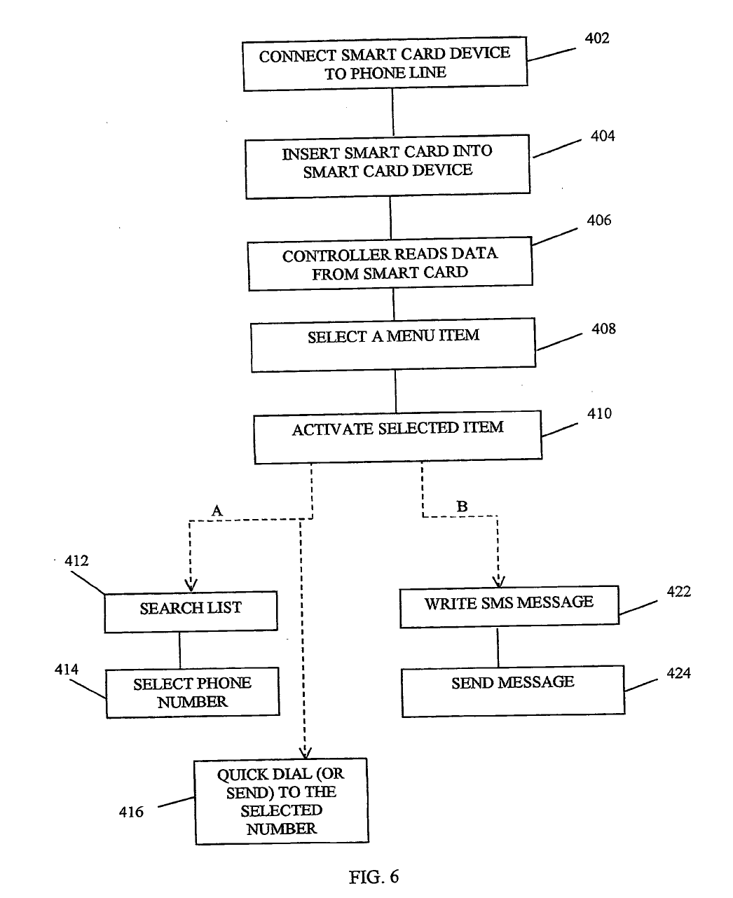

In an exemplary (telephone) embodiment of the invention, the smart card is programmed to contain personalized information, such as phone directory data, “quick dial” numbers and other keyed fusions, for example. The operation of the smart card device as a telephone personalizing device is now described with reference to the flow chart of FIG. 6, to which reference is now made.

The smart card device (of FIG. 2) is connected to the telephone line or hooked on a phone-cord (step 402). The person wishing to use the telephone inserts his personalized card (step 404) containing his personal and pre-loaded data into the smart card device. Steps 402 and 404 may be carried out in the reverse order.

The data is read by the device controller (step 406). The user may select a menu item from the list shown on the display (step 408) and then activate it (step 410).

In an alternative embodiment, the device may also contain a SIM, which may either completely replace the smart card, or add some encryption and security functions or store part of the data. In the case where personal and other data is completely integrated into the device SIM, (thus replacing the need for an external smart card), steps 404 and 406 are completely omitted, as they are fixed.

In an exemplary use, (as shown by dashed line—Route A), the user can select a phone number by searching from a list (step 412) by scrolling or entering the desire name and then activate the phone to call by selecting the desired number (step 414). Alternatively, a number may be called by using the selection (step 416) that is a single number has been programmed as a designated telephone number.

In a further exemplary embodiment of the invention, the smart card device 150 may be used to send an SMS (Short Messaging System) message (as shown by dashed line—Route B). To write a message (step 422), the keys on the device or the telephone keys may be used. The display may be provided either by the device, the card or on the telephone. When the “send” button is pressed (step 424), the message is either sent via a telephone switch (service provider) provided by the telephone carrier, or sent to a dedicated SMS server for onward transmission to the destination.

The sending of an SMS requires a separation between the key pressing and the actual transmission. This service is performed by the device controller, that identifies the appropriate mode, and allows for editing a message, (write text, clear, and end), and transmitting it to a member from the phone book or to a newly inserted number.

In a further exemplary embodiment of the invention the smart card device 150 may be used as a means to receive SMS message that are directed to the card holder (or device holder, in the integrated SIM case).

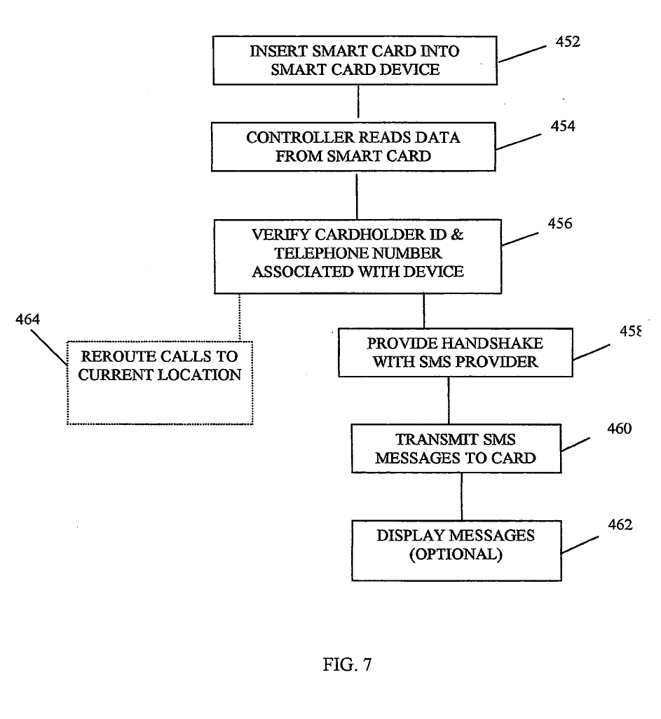

Reference is now made to FIG. 7, which is a flow chart illustration of an exemplary application utilizing the smart card device 150 to receive SMS messages.

When the card is inserted into the device (step 452), the device reads the card (step 454) to obtain information regarding the ID of the card (step 456). (Steps 452 and 454 may be omitted if the SIM is completely integrated to replace the external card, or may perform some of the external card functions).

Steps 456 and 458 may be carried out in several ways, as described below.

One way to implement steps 456, and 458, is that during the verification of the user's ID (step 456), the SMS server performs a handshake with the smart card, and also reads the “telephone identity”, that is the telephone number, which is associated with the user and which is designated to receive messages. This information is then transmitted also to the telephone exchange (the provider), which can update message reroute information (step 458). These steps may be initiated, for example, by (automatically, or manually) dialling to the SMS server, and then transmitting the identification information, stored on the card. An additional level of security may be added by requiring the use of a PIN code (this may be an extension of step 456).

After verification of the user's ID and parameters (step 458), the SMS server transmits the SMS messages (step 460) stored on its server to the card and (optionally) displays the messages on the display screen (step 462).

By inserting the card into the device, in addition to the server identifying the cardholder's ID (step 456), the server is also notified about which telephone the card is connected to and thus, the current location of the card holder can be obtained. This information may be used to automatically update and reroute future calls to the card holder (“follow me”) (path A). Any calls directed to the numbers associated with the cardholder number (such as home and cellular phone numbers) can then be directed to his current location (step 464). This can be achieved, for example by the device (automatically, or manually) generating a signal to the switch, or by calling the designated server, whenever the card is inserted into a device. When the card is removed from the device, the reroute information is updated. That is, messages will be stored on the server until the card is connected to a device in possibly another location. The reroute information is accordingly updated.

Notification of the location of the smart card holder (for mail, SMS server, and for the “follow me” service, for example) may be automatically triggered by the insertion and removal of the card into and from the device, or alternatively by a manual telephone call utilizing the device keys. Alternatively, the location may be initiated by a standard call on the existing telephone line, or by transferring the location and identification information using control protocols, such as are common in cellar phones, for example.

When the card is inserted into the device, an automatic indication of unread messages may be provided. The messages may then be transferred to the card for previewing and for further action.

In each of the scenarios described above that involve a notification to the telephone exchange or to a remote server, there are two pieces of identifying information which must be obtained for the operation to be completed; the user identification, which is stored on the card; and the current location of the smart card, which is the local telephone number. The local telephone number is known at the PSTN exchange and therefore need not be sent explicitly, and is commonly (by default) transferred during any call, and in particular the call to the relevant SMS server.

The SMS server may be notified (step 458) by either generating an explicit call to the SMS server, such as a “1-800” call or other dedicated number, such as a predefined “follow me” service number. Alternatively, the SMS server information may be notified by sending control information, such as is commonly used with cellular phones.

Downloading SMS messages (steps 460,462) from the server may be activated either by means of a standard call or alternatively a dedicated number associated with an identified server. In the latter case, the card within the device would be configured to respond to a call from the dedicated number. Alternatively SMS messages may be downloaded using control protocols such as are common in cellular phones, for example.

In all cases, the SMS message may be stored on the card and displayed on the display screen The device may also generate signals to the telephones connected to the device for indicating that there are unread messages, which can be picked up later. Alternatively, the device may be configured with visual and audible activators, such as LEDs, and buzzes, for example.

The delivery of the SMS messages (step 460) stored on the SMS server to the smart card holder at his current location may be achieved in one of several ways:

a. If an explicit call was generated to the server—then during the same call—messages can be downloaded (This can be achieved by switching to data mode).

b. If control protocols are used, then another, similar control protocol may be used for transferring the SMS content.

c. Upon receiving a new message, the server can initiate a call to the device containing the smart card—which then automatically intercepts the SMS data on this call.

d. During any standard call to/from the card-device location, the SMS server can piggyback the SMS information, and transfer it to the card/device.

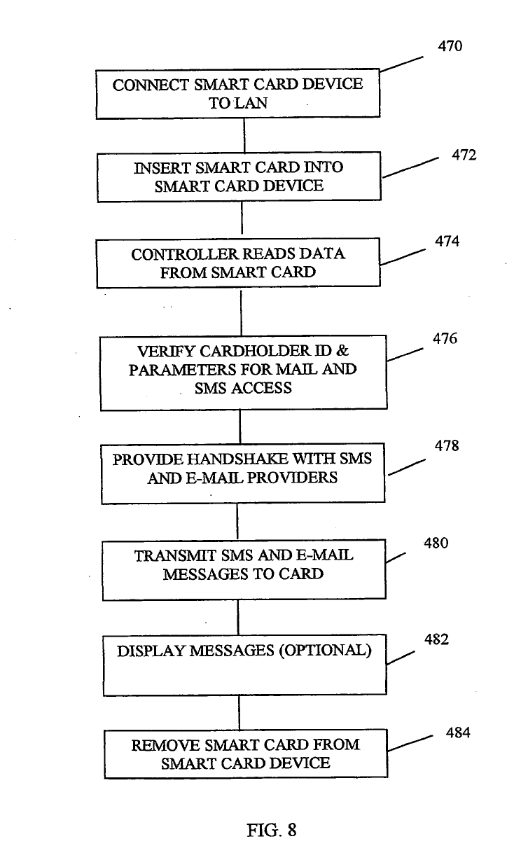

Reference is now made to FIG. 8, which is a flow chart illustration of a further exemplary application utilizing the smart card device 150 to receive e-mail and SMS messages over a LAN.

The smart card device is hooked into the LAN (step 470). This may be carried out by explicitly plugging the device through a cable, or through a wireless LAN interface. The device should be able to dynamically obtain an IP address, for example, through DHCP mechanism. Once the device is recognized by the LAN, the smart card may be inserted (or activated, if the smart card is included in the device)—step 472. Data such as the parameters for the various network services: for example, e-mail provider, account name and password for the provider, may then be read from the card (step 474).

Once these parameters are obtained, the communication with the mail server can be established. After verification of the user's ID (step 476) a handshake is performed (step 478).

Authentication of the user's identity may be verified using a PIN (optional) to complete steps 476 and 478. In step 482, e-mail messages are downloaded from the server to the card. The device can (optionally) display these messages (step 482), or just store them on card, for later use. When the card is removed (step 484), the communication to the mail server is terminated.

If the device is equipped with a keyboard and or a display, the user can also edit and send e-mail messages in a similar way. SMS messages can be handled in a similar way—with the SMS server.

The device is preferably, but not necessarily, a general-purpose smart card reader, and can thus be used for other network-oriented applications, such as authentication the caller and receiver identities, and or performing financial transactions.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1-45. (canceled)

46. A device comprising:
a smart card reader configured to communicate with a smart card and at least one network interface, wherein the at least one network interface is adapted for communication with any of a LAN, a Wireless LAN, a landline telephone, a cellular telephone, a peripheral-wire communications port, a wireless communications infra-red (IR) port, and an audio tones interrogator.

47. A device comprising:
a Secure Information Module (SIM); and
at least one network interface,
wherein the at least one network interface is adapted for communication with any of a LAN, a Wireless LAN, a landline telephone, a cellular telephone, a peripheral-wire communications port, a wireless communications infra-red (IR) port, and an audio tones interrogator.

48. A smart card comprising a network interface adapted for communication with any of a LAN, a Wireless LAN, a landline telephone, a cellular telephone, a peripheral-wire communications port, a wireless communications infra-red (IR) port, and an audio tones interrogator.

49. The device according to claim 46 wherein the smart card is configured to do at least one of the following:
store identification (ID) data associated with the smart card and store messages sent and received from any of an SMS server, an MMS server, and an e-mail server; and
support editing of any of SMS messages, MMS messages, and e-mail messages.

50. The device according to claim 46 configured to be connectable either between any of said telephones and the wall socket of a telephone line or between a telephone base and a telephone handset.

51. The device according to claim 46, configured to be integrated into said cellular telephone or a cellular telephone battery.

52. The device according to claim 46 wherein the device is integrated into any of said telephones or into a telephone handset.

53. A method for personalizing a telephone connectable to a PSTN, the method comprising the steps of:
connecting a device to a PSTN telephone line or to a telephone, the device comprising a SIM (Secure Information Module) or a smart card reader configured to communicate with the PSTN;
reading data stored on the SIM or on a smart card; and
affecting the-telephone behavior according to the data read from the SIM or card.

54. The method according to claim 53, further comprising the step of storing data on said SIM or said smart card.

55. The method of claim 53, further comprising the steps of:
selecting an action from a list of actions stored on either the SIM or the card; and
activating the telephone to perform the selected action.

56. The method according to claim- 55, wherein the step of activating comprises at least one of a list of actions including: dialing a telephone number, sending any of an SMS message, an MMS message, and an e-mail message via a service provider or dedicated server, changing to a new list, adding and editing telephone numbers, allocating “quick dial” numbers and accessing a call register of received, dialed and missed calls; and further comprising storing the result of the step of performing on the SIM or the card.

57. The method according to claim 53, further comprising the step of identifying the SIM or smart card owner.

58. A method for receiving any of SMS messages, MMS messages, and e-mail messages via a network interface, the network interface comprising either of a PSTN and a LAN or a Wireless LAN, the method comprising the steps of:
connecting a device to the network interface, said device comprising a controller in communication with an internal SIM (Secure Information Module) or a smart card reader;
reading identification data (ID) from the SIM or a smart card; and
performing a handshake with any of an SMS server, an MMS server, and an e-mail server via the network interface.

59. The method according to claim 58, wherein the step of performing a handshake comprises the steps of:
i. transmitting the ID to said server; and
ii. said server downloading said messages respectively associated with the ID of the SIM or card.

60. A method according to claim 53 for automatically rerouting data services to current location, the method comprising the steps of:
sending identification information stored on a SIM or a smart card to a service provider; and
accepting the data messages and telephone calls associated with the identification information at the current location,
wherein the data services comprises any of telephone calls, SMS messages, MMS messages, and e-mail messages, and
wherein the current location comprises one of a group including a landline telephone connectable to any of a PSTN, a cellular telephone, and a LAN or Wireless LAN access point.

61. A method according to claim 53 and further comprising:
personalizing a telephone by performing at least one of the following steps:
reading telephone personalization data stored on smart card, and
storing telephone personalization data on the smart card.

62. The device according to claim 47 and further comprising a smart card configured to perform at least one of the following steps:
store identification (ID) data associated with the smart card and to store messages sent and received from any of an SMS server, an MMS server, and an e-mail server, and
support editing of any of SMS messages, MMS messages, and e-mail messages.

63. The device according to claim 48 wherein the smart card is configured to perform at least one of the following steps:
store identification (ID) data associated with the smart card and to store messages sent and received from any of an SMS server, an MMS server, and an e-mail server, and
support editing of any of SMS messages, MMS messages, and e-mail messages.

64. The device according to claim 47 configured to be connectable either between a telephone and the wall socket of a telephone line or between a telephone base and a telephone handset.

65. The device according to claim 47 wherein the device is integrated into any of said telephones or into a telephone handset.
